(19) United States
(12) Patent Application Publication
(10) Pub. No.: US 2006/0066095 A1
(43) Pub. Date: Mar. 30, 2006

(54) V-fold information presentation device

(76) Inventor: Douglas F. Haack, Carlsbad, CA (US)

Correspondence Address: DOUGLAS HAACK, 2729 TIBURON AVE, CARLSBAD, CA, 92008, US

(21) Appl. No.: 10/950,369

(22) Filed: Sep. 27, 2004

(51) Int. Cl. B42D 15/00

(52) U.S. Cl. 283/65

(57) ABSTRACT

My V-Fold information presentation device is commonly called a Slide Rule Calculator (SRC). Two embodiments comprising a body enclosure sleeve (91) and single folded sliding insert (7) or two separate sliding inserts (20) and (21). Distributed as a flat partially printed die-cut shapes for overprinting on a desktop PC printer. Allowing a sales person to individually personalize the device to a prospective client.

The SRC sleeve's two flat sides (1) and (1a) have window cut-outs. Information is imprinted at right angles, opposed at 180 degrees—along or adjacent to each long side of each window cut-out, designated (91A), (91B), (91C) and (91D). There are two pairs of opposed data lists. Used with a slider's A & B side, the arrangement actually doubles the comparative results that can normally be aligned and viewed.

The two embodiments have two V-fold panels for three staples, or four V-fold panels for six staples. Both embodiments have six strategically placed half circular cut-out apertures (4), (4a), (4b), 4c), (4d) and (4e).

After over printing, the staples are affixed through and hidden behind the hinged cut-out apertures. The staples attach to two or four V-fold panels (2), (2a), (2b) and (2c). Insert slide (7) for embodiment #1, and slide (20) and (21) to complete assembly of embodiment #2.

### CROSS-REFERENCE TO RELATED APPLICATION

Not Applicable

### FEDERALLY SPONSORED RESEARCH

Not Applicable

### SEQUENCE LISTING OR PROGRAM

### Not Applicable

REFERENCES CITED

| | | | |
|---|---|---|---|
| 5,449,890 | 9/1995 | van Neck | 235/70R |
| 4,132,348 | 1/1979 | BROMBERG | 35/75 |
| 3,902,656 | 9/1975 | ROTHCHILD | 235/70 |
| 3,441,208 | 4/1969 | GOLDSTEIN | 235/70 |
| 3,025,767 | 3,1962 | BUFFALO | 93/1 |
| 2,632,963 | 3/1953 | DRURY | 35/39 |
| 2,531,633 | 6/1949 | LAURIN | 235/89 |
| 2,335,713 | 11/1943 | VOGEL | 116/135 |
| 2,240,226 | 4/1941 | ROSS | 235/89 R |
| 1,902,121 | 3/1933 | GALLAGHER | 40/65 |
| 1,666,337 | 4/1928 | McDADE | 35/75 |

### BACKGROUND OF THE INVENTION

### Field of Invention

This application relates to an Information Presentation Device—known in the previous art as Slide Rule Calculator (SRC).

### BACKGROUND OF THE INVENTION

Slide Rule Calculators do not actively calculate an answer or result. They passively display a selected or outlined portion of a pre-calculated table or matrix on the slider, aligned with the comparative data on the outer body enclosure.

The SRC is a ‘quick reference device’, usually rectangular in shape, having the proportions of various sized mailing envelope/s. Comprising a sleeve with a window aperture or more than one aperture, and a separate slide/r component. The mechanics is well known and well established in the previous art and many variations exist. The information displayed can be numerical or analog or a combination.

SRC's are mass manufactured for the financial and investment industry. Banks, insurance firms, mortgage brokers, stock brokers will give the SRC gratis to their clients as good will marketing give-a-way.

The previous art indicates a diverse range of special usage, ranging from finance, medicine, pharmaceutical, engineering, civil engineering, photography, curtain pleating, bombing and artillery calculations, as a teaching aid for music students.

The real estate industry has retail stores selling every conceivable real estate marketing aid useful to an agent or broker. Generic mortgage interest SRC's are available.

### BACKGROUND OF THE INVENTION

### Advantages

The previous art show no particular further development in this seemingly simple device.

My application will present an SRC design generally not suitable for the mass market. A novel embodiment for use by small business, where ‘de-genericizing’ and ‘individualizing’ the SRC is important and easily achieved with this applicant's base design.

Advantage A—Embodiment #1 and Embodiment #2—This application will present my flat and unassembled format—allowing the easy imprinting with the sales persons details and even personalizing a message to the client or recipient, directly onto the SRC. By using an in expensive desktop PC printer, found in most homes and businesses today. Thus bettering any chances for establishing a marketing relationship and a subsequent sales connection.

After overprinting the sales person will staple the unit together, and insert the slider. With attractive graphics applied, this type of direct marketing informational quick reference device is less likely to be discarded. A business card cannot have the same impact.

See U.S. Pat. No. 4,132,348 to Bromberg et al. (1979). Bromberg mass manufacturers in a fully printed form. Remoistenable glue or peel-off contact adhesive is applied during or at the end phase of manufacture. His patented format is expressly for attachment and distribution via magazines and consumer items. His examples of being part of cartons, labels and other packaged items, may entail the SRC being an integral part of the manufacturing process. NOT suitable for small batch distribution and for overprinting of a personalized image and message.

Advantage B—Embodiment #1—My application will present a novel method of assembling the body enclosure sleeve (after personalizing to the recipient) by simply stapling together. The staples are unobtrusively hidden from view. SRC's are never assembled by stapling together. They are glued or on occasions are rivetted. Rivetting applies to FIGS. #106 and #106C, drawing pages #01 and #07A.

Advantage C—Embodiment #1 and Embodiment #2—My application will present a method of doubling the available resultant comparison information, without resorting to a difficult to see and read smaller point sized type face.

In relation to (C) above, see U.S. Pat. No. 4,132,348 to Bromberg et al. (1979). Bromberg claims his method achieves doubling and possible tripling of available data comparison. I believe this is not the case. His method uses a slide with folded panels. i.e. A total combination of four or six read-out slider panels. (See his drawings—FIG. 10 and FIG. 11 on pages 4 of 10.

The established working method or principal of a SRC is in the comparison or comparative aspect at the data alignment point/s of slide/r and sleeve. Bromberg has doubled and tripled the available slider matrix data only. Without doubling the imprinted sleeve's comparative alignment data. No full or real doubling or tripling of comparison results is achieved or apparent. His method doubles or triples the slider data only

Upon examining Bromberg's patent description and drawings, see FIGS. 2, 3, and 4, on pages 3 of 10, Bromberg illustrates a Metric to English measurement conversion SRC. There is no illustrated comparative doubling or tripling, of imprinted data on the sleeve. His drawings simply depict a folded slider with four or six slider read-out panels. Bromberg does not clarify this anomaly.

Advantage D—Embodiment #2—My application will present a method of construction that compartmentalizes the inner sleeve, thus allowing a second slider to be inserted and manipulated. This allows a further doubling of the comparison information. This double slider aspect allows there to be additional or more continuous matrix data or two different types of comparison data—housed in one compartmentalized sleeve

### SUMMARY

This application proclaims a concrete further development to a quick reference utility item that has been used in industry and commerce for over 90 years. This new embodiment is directed to the self employed and to small business operatives.

### DRAWINGS LIST AND DRAWING EXPLANATIONS

Drawing #201—FIG. 102 is this application's embodiment #1.

FIG. 104 is this application's embodiment #2.

FIG. 108—The industry does use another SRC design markedly different from the FIGS. #106, #102 and 104 illustrated.

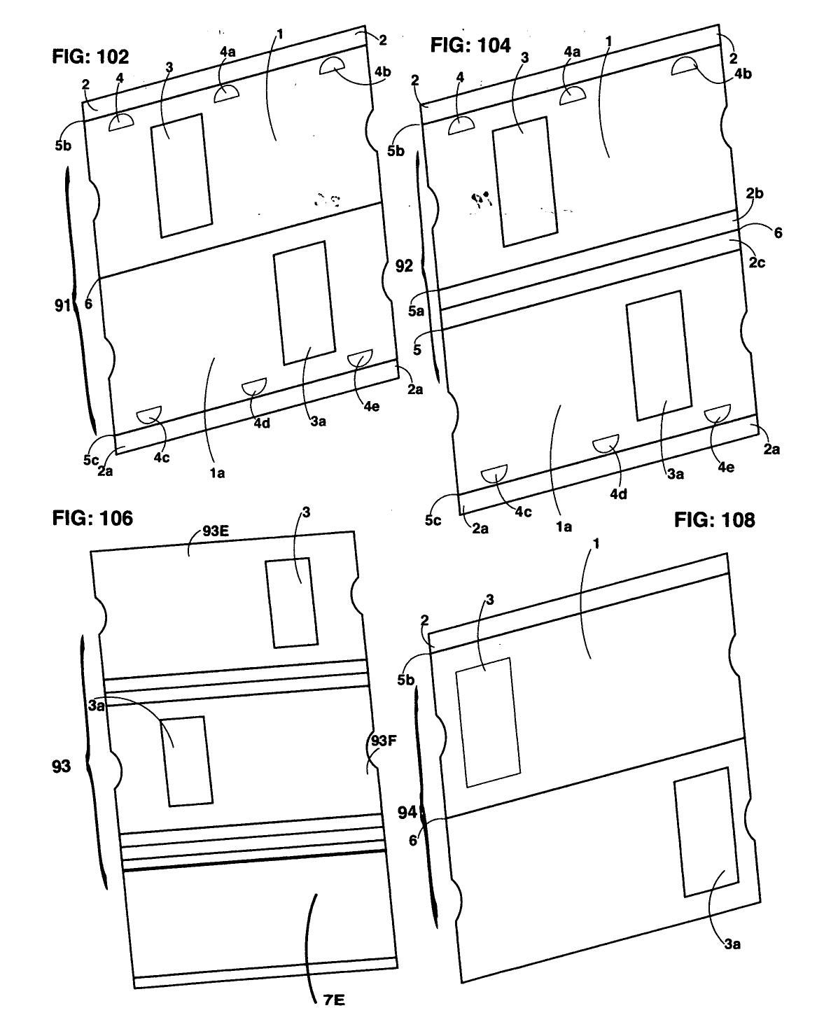

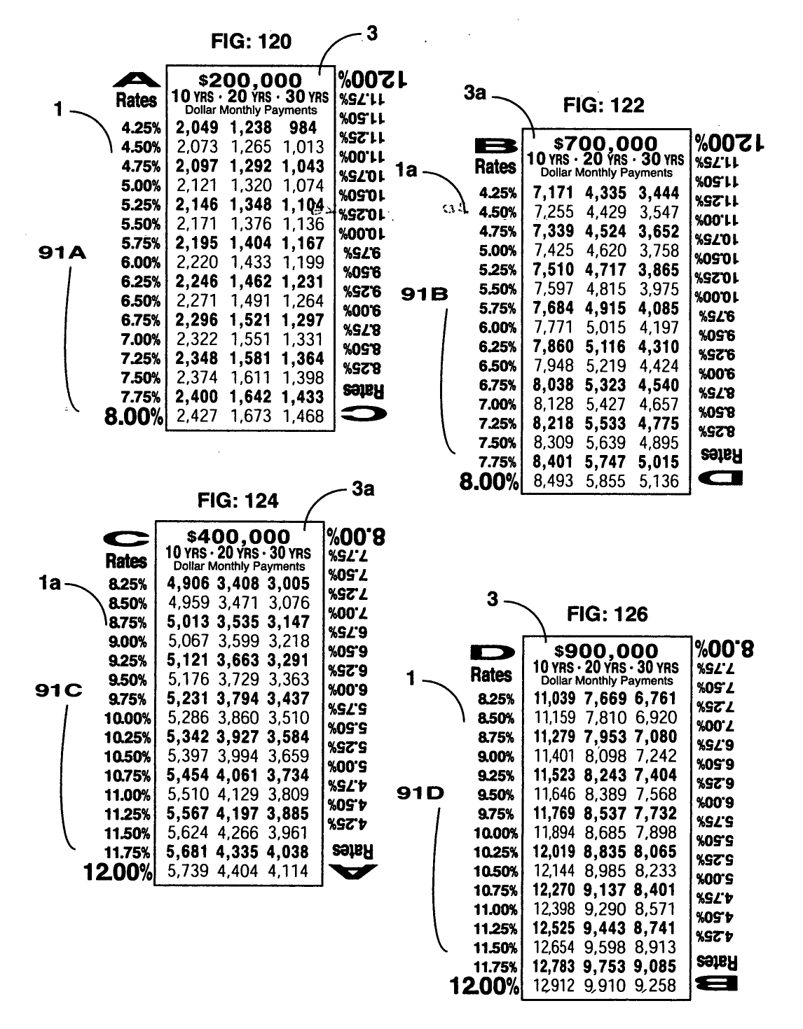

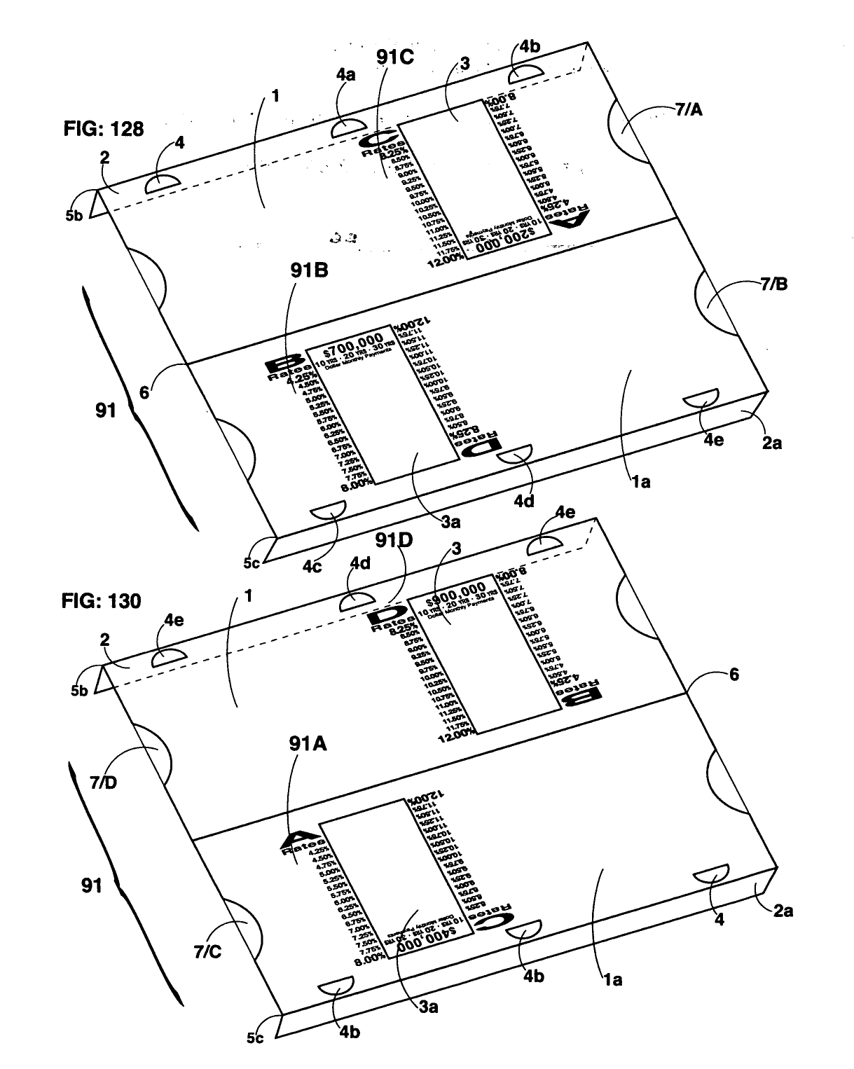

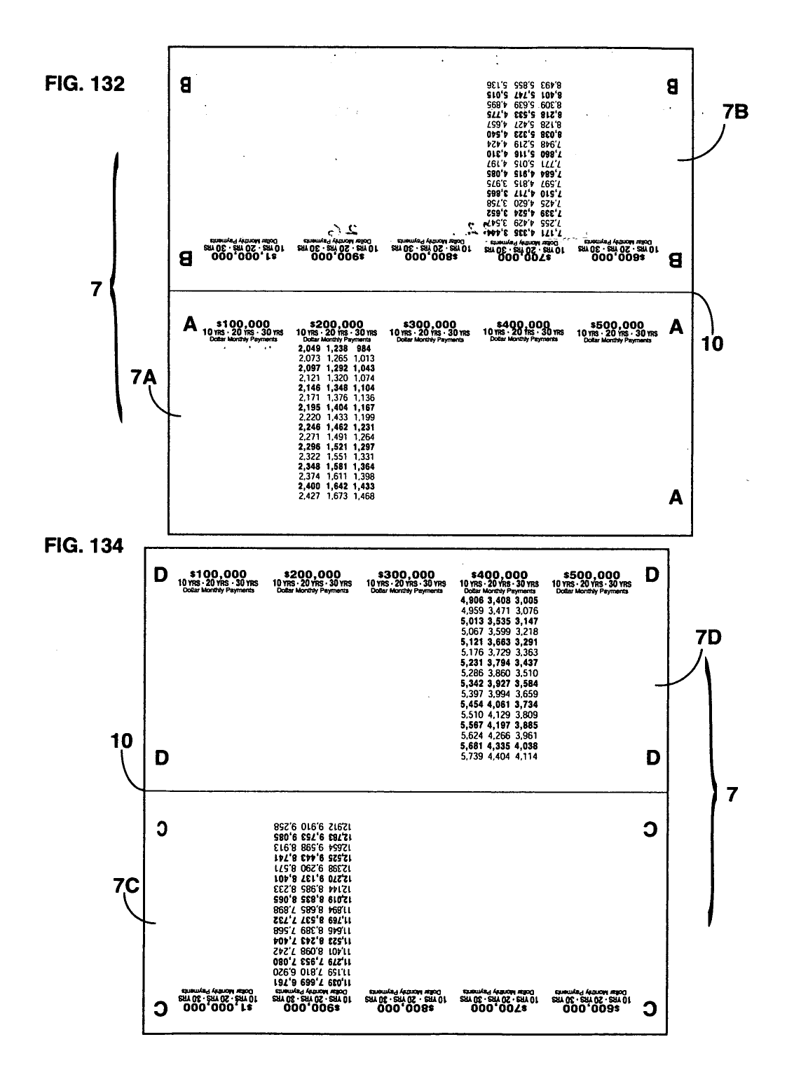

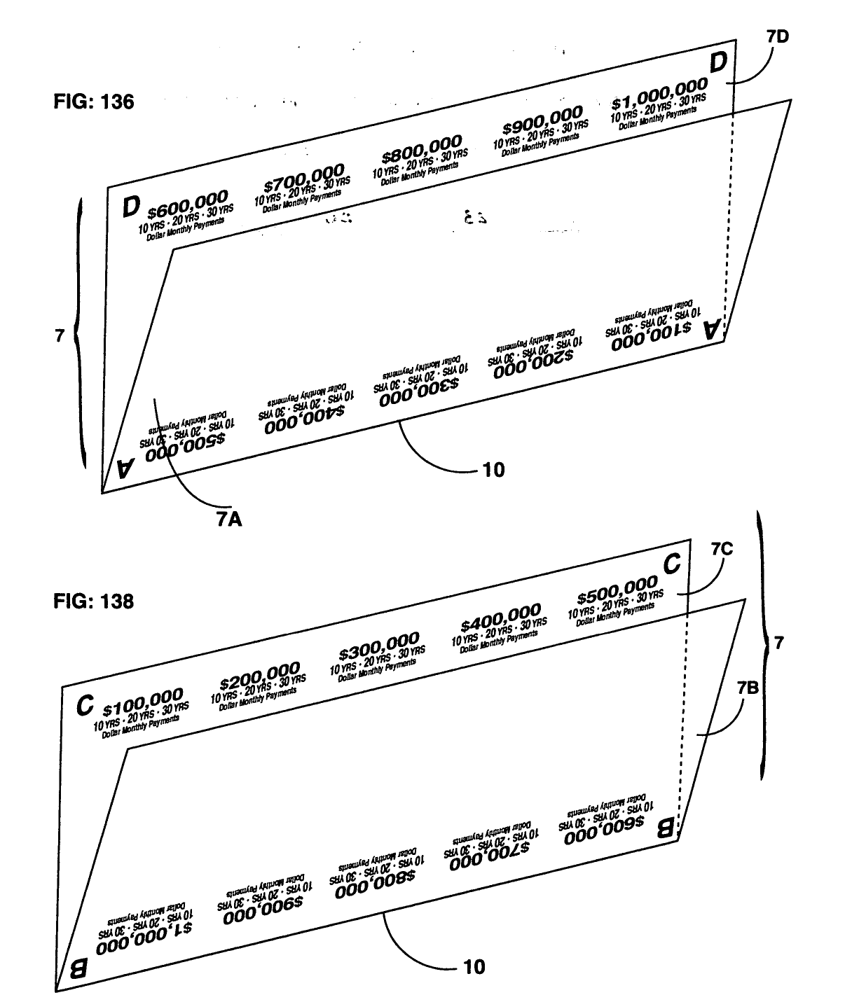

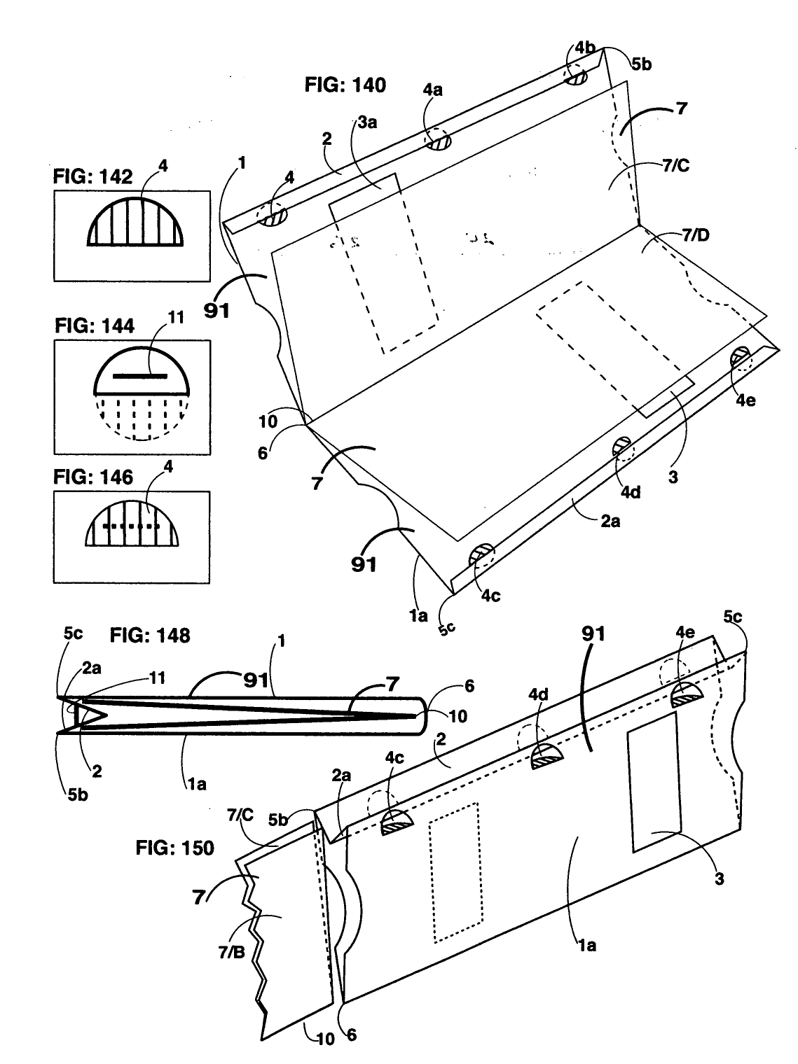

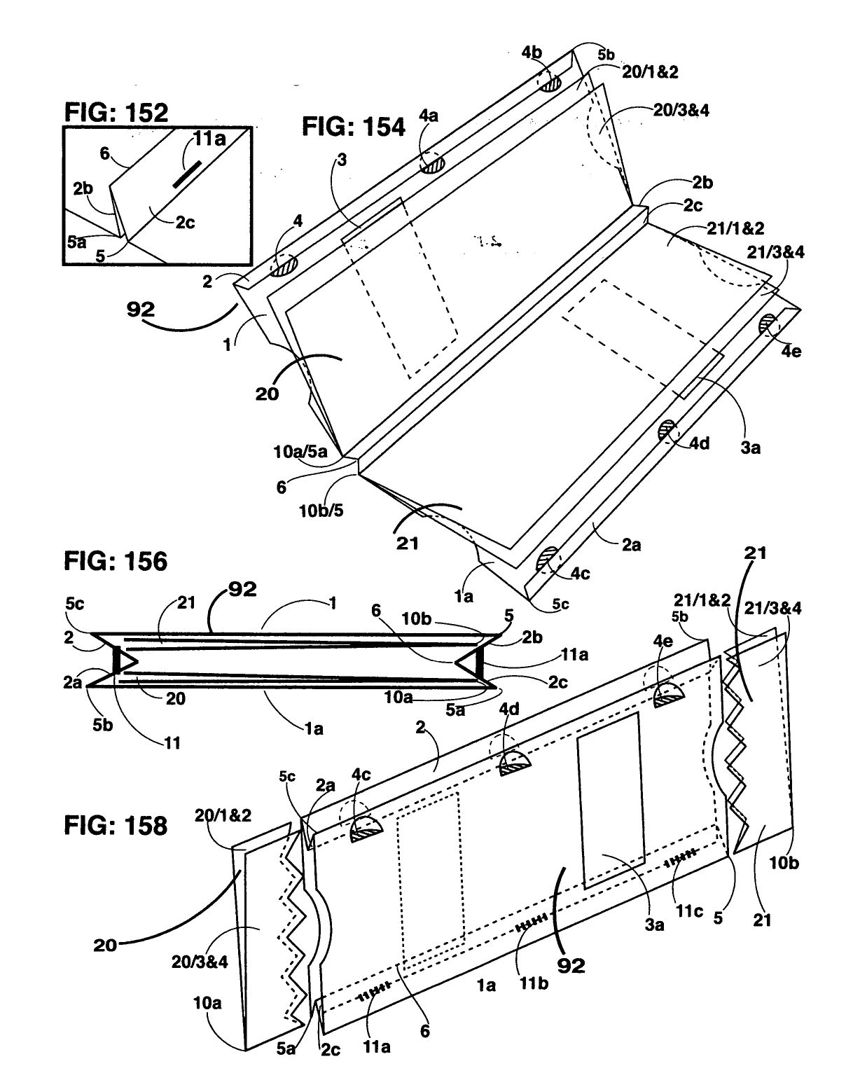

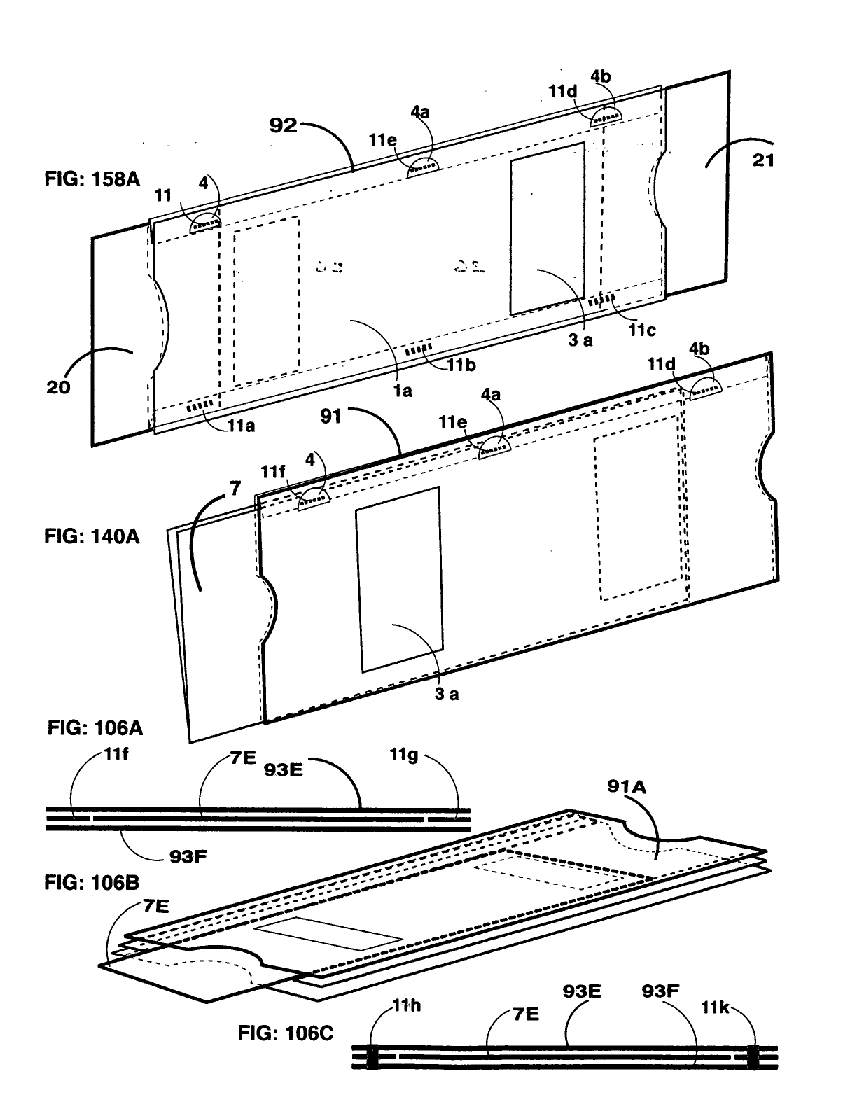

FIG. #108—is the most common SRC sleeve or outer body sleeve design with glue panel.

Drawing #202—comprises FIGS. 120. #122. #124 and #126. The figures represent the SRC's sleeve and slide/r—viewed in position with interest rates and payments matrix data showing.

Drawing #203—FIG. 128 shows a flattened SRC. View 91/C/1a with column $200,000 and View 91/D/1 with column $700,000—dollar amounts borrowed.

FIG. #130 shows both sides of a flattened SRC. View 100/D with column $400,000 and View 100/C WITH column $900,000—dollar amounts borrowed.

Drawing #204—FIGS. #132 and 134 shows slider 7, panel side 7A & 7B and slider panels side 7C & 7D.

Drawing #205—FIGS. 136 and #138 show a folded slider 7, with panel image 7D backed by panel image 7A.

FIG. 138 shows slider 7, with panel image 7C backed by panel image 7B. Note how the column heads (tops) are orientated when in the folded position.

Drawing #206—FIG. #140 (embodiment #1) shows the unassembled SRC sleeve 91 open with its partially folded single slider 7.

FIG. #148 shows a side view of an assembled and stapled sleeve 91 with the slider inserted in the final assembled position and one of three staple/s affixed.

FIGS. #142, #144, #146 show a close-up of a half circle flap in a three step assembly stapling sequence. FIG. #142—a closed aperture. FIG. #144—an open aperture with staple affixed. FIG. #146—re-closed aperture. FIG. #150 a view ready for stapling (without slider).

Drawing #207—This is embodiment #2—FIGS. #152, #154, #156, and #158, introducing two extra V-fold panels 2b and 2c of the SRC sleeve 92 and sliders 20 and 21.

FIGS. 152 shows a close up view of staple 11a (one of three) affixed to flaps 2b and 2c folded on folding lines 5 and 5a.

FIG. #156 shows a side view of an assembled and stapled body enclosure 92 with two sliders 20 and 21 inserted in the final divided assembled position with two staples of six.

FIG. #158 shows 3 staples in affixed position/s when panel 2b and 2c are fitted together.

Drawing #207A—FIGS. #158A, #140A, #106A, #106B, and #106C.

FIGS. #158A and #140A, show the assembled SRC's with all three or six staples affixed for both embodiment #1 and embodiment #2.

FIGS. #106A, #106B, and #106C—These figures relate back to FIG. #106 on drawing page #201, and not for patent examination. Industry known embodiment.

### DRAWINGS REFERENCE NUMERALS

1 The side panel of the SRC sleeve—91/92
1b The side panel of the SRC sleeve—91/92
2 V-Fold staple panel on side panel 1—91/92
2a V-Fold staple panel on side panel 1a—91/92
2b V-Fold staple panel on side panel 1—91/92
2c V-Fold staple panel on side panel 1a—91/92
3 SRC window aperture side CA—91/92/93/94
3a SRC window aperture side BD—91/92/93/94
4 First Half circle staple access aperture—91/92
4a Second Half circle staple access aperture—91/92
4b Third Half circle staple access aperture—91/92
4c Fourth half circle staple access aperture—91/92
4d Fifth Half circle staple access aperture—91/92
4e Sixth Half circle staple access aperture—91/92
5 Fold line adjacent panel 2c—92
5a Fold line adjacent panel 2b—92
6 Fold line mid fold of sleeve —91/92
7 Folded slider—91
7A Slider 7 panel A—91/#204
7B Slider 7 panel B—91/#204
7C Slider 7 panel C—91/#205
7D Slider 7 panel D—91/#205
7E Single slider of known industry embodiment—#201/FIG. 106
8 to 9—no designation
10 Mid fold slider 7—91
10a Mid fold slider 20—92
10b Mid fold slider 21—92
11 staple affixed to panels 2 and 2a—91/92
11a staple affixed to panels 2b and 2c—92
11b Staple affixed to panels 2b and 2c—92
11c Staple affixed to panels 2 and 2a—92
11d Staple affixed to panels 2 and 2a—91/92
11e Staple affixed to panels 2 and 2a—91/92
11f One slide strip or guide glued to both body side panels—93/207A/FIG: 106A
11g Other Slide strip or guide glued to both body side panels—93/207A/FIG: 106A
11h One slide strip or guide rivetted to both body side panels—93/207A/FIG: 106C
11k Other Slide strip or guide rivetted to both body side panels—93/207A/FIG: 106C
12 to 19—no designation
20 Slider #1—92
20/1 &2 Slider matrix panel 1&2 of 4—92
20/3&4 Slider matrix panel 3&4 of 4—92
21 Slider #2—92
21/1&2 Display panel 1&2 of 4—92
21/3&3 Display panel 3&4 of 4—92
22 thru 90—no designation
91 This application's embodiment #1 SRC body—91
91A/1 A/C Rates from 4.25% to 12.0%—$200,000 column—91/92
91B/1a B/D Rates from 4.25% to 12.0%—$700,000 column—91/92
91C/1a C/A Rates from 12.0% to 4.25%—$400,000 column—91/92
91/D/1 D/B Rates from 12.0% to 4.25%—$900,000 column—91/92
92 This application's embodiment #2 SRC body—92
93 Known industry embodiment
93E One side panel—93/FIG. 106/207A
93F Other side panel—93/FIG. 106/207A
94 Known industry embodiment

### DETAILED DESCRIPTION

### EMBODIMENT #1

EMBODIMENT 1: Two V-fold flaps or folded panels 2 and 2a are introduced. When these two panels are folded inwards along the fold lines 5 and 5a, aligned and in contact, three staples are affixed to panels 2 and 2a, through the half circle apertures, 4, 4a, 4b, 4c, 4d, and 4e. See drawing pages #206, figures #140, #142, #144, #146, #148 and #150

EMBODIMENT 1—My method of doubling the comparison information on the outer sleeve is illustrated in the following drawing pages: #202, #203, #204 and #205.

See illustrated the use of both longer sides of a cut-out aperture/s or window/s. The sleeve's two sides have window cut-outs. Interest rates information is imprinted and opposed at 180 degrees—along or adjacent to each long side of each window cut-out.

Drawing #02 and #3, FIGS. 128 and #130 depicts a working arrangement of a mortgage payments SRC, a suitable example. Mortgage SRC's are common in the previous art going back more than 50 years. The information read-out on the FIGS. 120. #122. #124 and #126, show columns of monthly payments, imprinted on the slider. The column listings are headed by the principal amount borrowed, over three possible time periods of a loan and the monthly payments tabular matrix.

The individual monthly payment/s column on the slider are aligned with sleeve's imprinted interest rates, labeled in quarter percentile increments: see

FIG: 120 view will be referred to as: “RATES ‘A’—VIEW 91/A @ $400,000

FIG: 122 view will be referred to as: “RATES ‘B’—VIEW 91/B @ $700,000

FIG: 124 view will be referred to as: “RATES ‘C’—VIEW 91/C @ $400,000

FIG: 126 view will be referred to as: “RATES ‘D’—VIEW 91/D @ $700,000

Drawing #204 (FIG: 132, 134), show the listed interest rates imprinted on opposite sides of sleeve 7 in flat unassembled form. Strike-thru indicates material deleted.

Drawing #204 and #205 (FIGS: #132/134 and #136/138)—Side A/B and side C/D are printed on opposite sides of the slider. The position of the printed image back-up must have the A/B side $500,0000 column directly backed to the C/D side $500,0000 column, opposite orientation. The A/B side $1,000,0000 column directly backs to the C/D side $1,000,0000 column, again opposite orientation.

In Drawing #202—(FIGS: 120 thru #126), the ‘C’ rates are shown opposed 180 degrees to the ‘A’ rates. The ‘D’ rates are shown opposed 180 degrees to the ‘B’ rates etc. This 180 degrees opposed arrangement allows the SRC to display a two-fold increase of interest rates, (from 4.25% to 8% and 8.25% to 12%), not shown in this way in any previous art that this applicant has found.

A six or eight panel panel folded slider (made of a thinner material) may also be used. Not illustrated.

The opposing back-side SRC window view B/D aperture, will display the $700,000 matrix column, aligned to the repeated percentile rates (4.25°-8.0%) and displaying the sequentially listed monthly payments of the ‘B percentile rates’, on the B/D side of the sleeve. See Drawing #05 (FIG: 136 & 138).

When viewing the ‘A’ rates or the ‘B’ rates (4.25% to 8.0%) and one wishes to view the 8.25%-12% percentile increments listing, do the following. Withdraw the slider, turn the sleeve enclosure horizontally 180 degrees, re-fold and re-insert the slider to display the $400,000 matrix column of the C/D panels, aligned with the C/A sleeve side.

The slider will have each rates display panel prominently identified (say, in each corner) and before inserting the slider one takes care to match and color match the rates identifiers on slider and the outer sleeve.

The opposing back-side SRC window aperture, will display ‘D’ rates at the $900,000 matrix column, aligned to the repeated percentile rates (8.25%-12%). Displaying the sequentially listed monthly payments of the ‘D percentile rates’, on the D/B side of the body enclosure.

For practical usage reasons, the sleeve ‘A/B’ interest rates and the matching sleeve matrix monthly payments will all be in one contrasting color. Both the ‘C/D’ interest rates and matching monthly payments too, will be in a suitably contrasting color, but noticeably a different color from the ‘A/B’ color.

This method increases the informational display area from 100% to 200%. Achieved by using both sides of an aperture window cut-out on the body enclosure, in an opposed 180 degree positional display arrangement as described and illustrated.

NOTE: this informational doubling arrangement is suitable for use with all known rectangular SRC designs being commonly used and appears to be unknown in the previous art.

### DETAILED DESCRIPTION

### EMBODIMENT 2

See Drawing #207—(FIGS. 152, #154, #156, and #158)—

This second version (with two sliders) of my SRC will require differently orientated slider images from those discussed in embodiment #1. This revised orientation is not illustrated as the underlying principals remain the same. This embodiment may also have two single sliders, each with four display panels. Two triple sliders each with 6 display panels may also be used.

The afore mentioned informational doubling arrangement, the 180 degrees opposed window edge listing is also used on this embodiment. Again, the underlying principals remain the same and need no further illustration.

In this second embodiment, two extra V-fold panels 2b and 2c are introduced. When aligned and in contact, three more staples will be affixed. Staples 11a, 11b and 11c are affixed first in the assembly routine (see fig: #152). This embodiment uses a total of six staples.

This four V-flap arrangement divides the inner sleeve into two compartments (for two sliders) when panels 2 and 2c are aligned and stapled, completing the assembly—see FIGS. 156 and #158 showing the compartment division. Panels 2b, 2c and 2, 2a can be wider than illustrated. If the panel width of 2b and 2c is doubled or tripled, the stapled panels will almost meet, thus forming higher or wider inner compartmental walls (they should not touch or over lap). This uses more paper board, but may be desirable on occasions.

To fully assemble the SRC “embodiment 2′, do the following:

1) (View drawing #07 and FIG. 158). Pre-fold panels 2, 2a, 2b and 2c along their fold lines 5, 5a and 5b, 5c.

2) Push the half circle flaps inwards—half circle flaps 4, 4a, 4b and 4c, 4d, 4e.

3) Staple panels 2b and 2c in aligned contact with each other with three staples. The staple are affixed into the inside surface of the SRC, thus forming the first inner wall segment.

Use a plier type stapler for maximum pressure to flatten the metal staples onto and into the paper board surface. Place one staple at the mid point of the aligned and touching panels and in close proximity to the 5 and 5a fold lines. Place another staple on either side of the middle staple, approximately 10 mm from each end lengthwise.

4) Place the sleeve onto a flat surface, and position near a convenient edge. Now bring sleeve panels 1 and 1a in contact with each other and smooth out flat the now partially stapled sleeve. Align in contact panels 2 and 2a, both are folded inwards along their fold lines 5b and 5c.

Ensure all half circle apertures have their half flap folded down and in contact with the inside of sleeve sides panels 1 and 1a.

5) Applying light pressure with your spread out fingers and the heal of your hand, keeping panels 2 and 2a and all six half circle apertures in their aligned and flattened internal position.

6) This position will allow staple access via or through the open half circle apertures. The remaining three staples are affixed into contacting panels 2 and 2a through the aligned half circle apertures. This permanently assembles and closes the sleeve.

7) One now balloons the sleeve by applying a light pressure on each long sleeve edge with the thumb and fingers. This action opens or balloons the sleeve, allowing finger access into the window cut-out apertures 3 and 3a. One can now manipulate the half circle flaps back to their original positions. The flaps will now remain in their flat paper board surface positions, thus unobtrusively hiding each staple from view. Insert the slider for free travel within the sleeve.

The examiner will notice the window cut-out apertures 3 and 3a are each inboard from each SRC end edge. The inboard spacing is one window width. This allows easy finger access when manipulating the half circle flaps back to their original positions on side panels 1 and 1a.

Sleeve assembly closure can also be achieved with peel-off pressure sensitive adhesive tape or any other form of adhesive, the industry standard. If adhesive is used then the half circle apertures become unnecessary, and remain closed

The above assembly and closure instructions also apply to embodiment #1. Step two and three can be ignored, as embodiment #1 has 3 staples only.

1) The information doubling arrangement—using the described ‘180 degrees opposed comparative data listing’ on the sleeve window apertures of the SRC. This is a practical and further development, adding extra utility to the slide rule calculator (SRC).

2) The two V-Flap or four V-Flap final assembly staple affixing panels, allows the following novel advantages:
i) the use of a common stapler to fully close and assembly the SRC.
ii) Two stapled or glued V-Flaps form a wall or compartment within the body or sleeve of the SRC, thus forming a partial separating wall or a front and back compartment for the two individual single or multi-folded sliders.

3) The unique function of the six half circle apertures located on the V-Flaps. Allowing staple access to the inside of the partially assembled body sleeve of the SRC. The affixed staples are hidden from view behind the half circle cut-out aperture flaps. The staples become visually unobtrusive in their affixing capacity.

4) The advantages to small business by the partially printed flat base shape and the “to be assembled” design of the described SRC's in their two major embodiments. Their utility value in any overprinting on a common PC printer, adds to the potential relationship building and marketing factor value to a prospective or established business relationship.
